(19) United States
(12) Patent Application Publication
(10) Pub. No.: US 2016/0085998 A1
(43) Pub. Date: Mar. 24, 2016

(54) ELECTRONIC DEVICE AND SECURITY PROTECTION METHOD FOR THE ELECTRONIC DEVICE

(71) Applicant: Chiun Mai Communication Systems, Inc., New Taipei (TW)

(72) Inventor: WEI-CHIA LAN, New Taipei (TW)

(21) Appl. No.: 14/700,389

(22) Filed: Apr. 30, 2015

(30) Foreign Application Priority Data
Sep. 23, 2014 (CN) 201410492266.2

(51) Int. Cl. G06F 21/88

(52) U.S. Cl. CPC G06F 21/88

(57) ABSTRACT

A method for protecting security of an electronic device includes setting one or more security operations on the electronic device by an owner of the electronic device. When a security condition associated with a security operation performed on the electronic device is false after the electronic device is activated from a sleep mode, a video is recorded for a predetermined duration using a camera of the electronic device, and the video is sent to a predetermined e-mail address stored in the storage device. According to the video, the owner of the electronic device can identify and find the current user of the electronic device.

### CROSS-REFERENCE TO RELATED APPLICATIONS

This application claims priority to Chinese Patent Application No. 201410492266.2 filed on Sep. 23, 2014, the contents of which are incorporated by reference herein.

### FIELD

The subject matter herein generally relates to the field of security technology, and particularly to security of an electronic device.

### BACKGROUND

An electronic device (e.g., a mobile phone) is designed to be lightweight and easily portable. However, if the electronic device is lost or stolen, it can be hard to get back.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device including a security system.

FIG. 2 is a block diagram of an example embodiment of function modules of the security system in the electronic device of FIG. 1.

FIG. 3 is a flowchart of an example embodiment of a method for protecting security of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

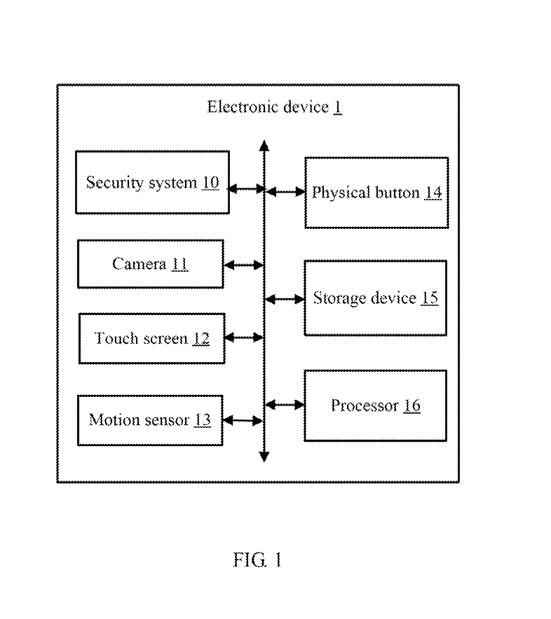

FIG. 1 is a block diagram of one example embodiment of an electronic device including a security system. In at least one embodiment, an electronic device 1 includes a security system 10. The electronic device 1 can be a smart phone, a personal digital assistant (PDA), a tablet computer, or other electronic device. The electronic device 1 further includes, but is not limited to, a camera 11, a touch screen 12, a motion sensor 13, a physical button 14, a storage device 15, and at least one processor 16. FIG. 1 illustrates only one example of the electronic device, other examples can include more or fewer components than as illustrated, or have a different configuration of the various components in other embodiments.

In at least one embodiment, a plurality of applications are installed in the electronic device 1. In at least one embodiment, an application is a program, or group of programs, that run on the electronic device 1. An application may be a mobile Web site bookmarking utility, a mobile-based instant messaging client, and may be other applications. The application includes a shortcut or a representative icon displayed on the touch screen 12 of the electronic device 1.

In at least one embodiment, the storage device 15 can include various types of non-transitory computer-readable storage mediums. For example, the storage device 15 can be an internal storage system, such as a flash memory, a random access memory (RAM) for temporary storage of information, and/or a read-only memory (ROM) for permanent storage of information. The storage device 15 can also be an external storage system, such as a hard disk, a storage card, or a data storage medium. The at least one processor 16 can be a central processing unit (CPU), a microprocessor, or other data processor chip that performs functions of the electronic device 1.

The security system 10 is configured to record video of a current user of the electronic device 1 using the camera 11, and send the video to a predetermined e-mail address. The video may assist an owner of the electronic device 1 in finding the current user of the electronic device 1 and retrieving the stolen electronic device 1.

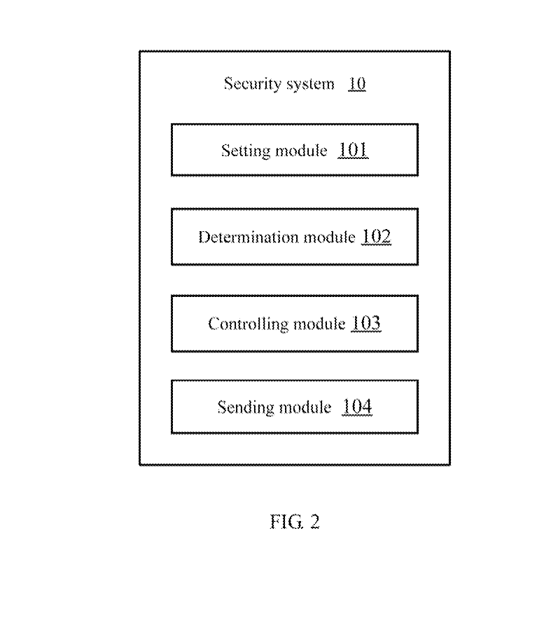

FIG. 2 is a block diagram of one embodiment of function modules of the security system. In at least one embodiment, the security system 10 can include a setting module 101, a determination module 102, a controlling module 103 and a sending module 104. The function modules 101, 102, 103, and 104 can include computerized codes in the form of one or more programs which are stored in the storage device 15. The at least one processor 16 executes the computerized codes to provide functions of the function modules 101-104.

The setting module 101 sets one or more security operations on the electronic device 1 by an owner of the electronic device 1. In at least one embodiment, the setting module 101 provides a user interface for the owner to execute the security operation on the electronic device 1 and the setting module 101 records the security operation.

In one embodiment, the security operation may include executing at least one predetermined application of the electronic device 1. In another embodiment, the security operation may further include at least one predetermined operation performed on the at least one predetermined application. The at least one predetermined application and the at least one predetermined operation are predetermined by the owner of the electronic device 1 when the owner sets the security operation through the setting module 101.

In an embodiment, the electronic device 1 may include one or more dummy applications that do nothing and just terminate immediately after being executed. The owner may set one or more dummy applications in the security operation to speed up the execution of the security operation, and set a predetermined sequence to execute the one or more dummy applications as a part of the security operation. For example, the one or more dummy applications may include a mobile web site bookmarking utility, a mobile-based instant messaging client, and a camera application. The owner may set the predetermined sequence as executing the camera application first, and then executing the mobile web site bookmarking utility, and then executing the mobile-based instant messaging client.

In an embodiment, the security operation may include dragging an icon of any one application displayed by the touch screen 12 along the predetermined path. The predetermined path is predetermined by the owner of the electronic device 1 when the owner sets the security operation through setting module 101. In another embodiment, the security operation may include dragging an icon of a predetermined application displayed by the touch screen 12 along the predetermined path. The predetermined path is preset by the owner of the electronic device 1 when the owner sets the security operation through the setting module 101. For example, the predetermined path may be dragging the icon of the predetermined application from the top of the touch screen 12 to the bottom of the touch screen 12.

In an embodiment, multiple desktops may be defined in a graphical user interface (GUI) displayed by the touch screen 12 and the security operation may include a predetermined sequence of switching operations for switching the current desktop of the GUI. The predetermined sequence is predetermined by the owner of the electronic device 1 when the owner sets the security operation through the setting module 101. For example, the predetermined sequence may be switching to the next desktop for three times followed by switching to the previous desktop for two times.

In an embodiment, the security operation may include at least one predetermined operation performed on at least one predetermined menu of a GUI displayed by the touch screen 12. The at least one predetermined menu and the at least one predetermined operation are predetermined by the owner of the electronic device 1 when the owner sets the security operation through the setting module 101. In another embodiment, the at least one predetermined menu may include at least one menu item predetermined by the owner and the security operation may further include selecting the at least one predetermined menu item. In an embodiment, the predetermined menu item is a dummy menu item that has no function other than completing the security operation.

In an embodiment, the security operation may include at least one predetermined touch operation performed on the touch screen 12 by an input tool. The input tool may be a stylus or a finger of the owner or the current user of the electronic device 1. The at least one predetermined touch operation is predetermined by the owner of the electronic device 1 when the owner sets the security operation through the setting module 101. For example, the at least one predetermined touch operation may include drawing a circle, a triangle, a square, or a cross on the touch screen 12, or touching one or more points of the touch screen 12 predetermined by the owner.

In an embodiment, the security operation may include at least one predetermined operation performed on the at least one physical button 14. The at least one predetermined operation is predetermined by the owner of the electronic device 1 when the owner sets the security operation through the setting module 101.

In an embodiment, the security operation may include a predetermined moving (such as rotation or shaking) of the electronic device 1 detected by the motion sensor 13. The predetermined moving is predetermined by the owner of the electronic device 1 when the owner sets the security operation through the setting module 101. The motion sensor 13 may include at least one of an accelerometer, a gyroscope sensor, an electronic compass and a barometer for detecting the movement of the electronic device 1.

In at least one embodiment, the setting module 101 further stores a predetermined e-mail address into the storage device 15. The predetermined e-mail address can be input by the owner of the electronic device 1 through the user interface.

The determination module 102 checks whether a security condition associated with a security operation performed on the electronic device 1 is true or false after the electronic device 1 is activated from a sleep mode. In an embodiment, the security condition is that the security operation is the first operation received by the electronic device 1 after the electronic device 1 is activated from the sleep mode. In another embodiment, the security condition is that the security operation is completely received by the electronic device 1 within a second predetermined duration after the electronic device 1 is activated from the sleep mode. In one embodiment, the second predetermined duration may be five seconds, ten seconds, one minute, three minutes, or five minutes, etc.

When the security condition associated with the security operation performed on the electronic device 1 is false, the controlling module 103 activates the camera 11 to record a video for a first predetermined duration. In some embodiments, the camera is set to a first side (e.g., a front side) of the electronic device 1, so that the camera 11 can capture a facial image of the current user of the electronic device 1. When the security condition associated with the security operation performed on the electronic device 1 is false, the current user of the electronic device 1 is determined not to be the owner of the electronic device 1. For example, the current user of the electronic device 1 may be a thief. Thus, the controlling module 104 turns on the camera 11 to record the video for the first predetermined duration (e.g., 5 seconds) using the camera 11 to extract facial images of the current user of the electronic device 1. Through the extracted facial images of the current user, the current user may be identified and found.

The sending module 104 stores the recorded video into the storage device 12, and sends the recorded video to the predetermined e-mail address stored in the storage device 12. In at least one embodiment, the sending module 104 turns on a wired or wireless network connection of the electronic device 1, and sends the video to the predetermined e-mail address through the network connection.

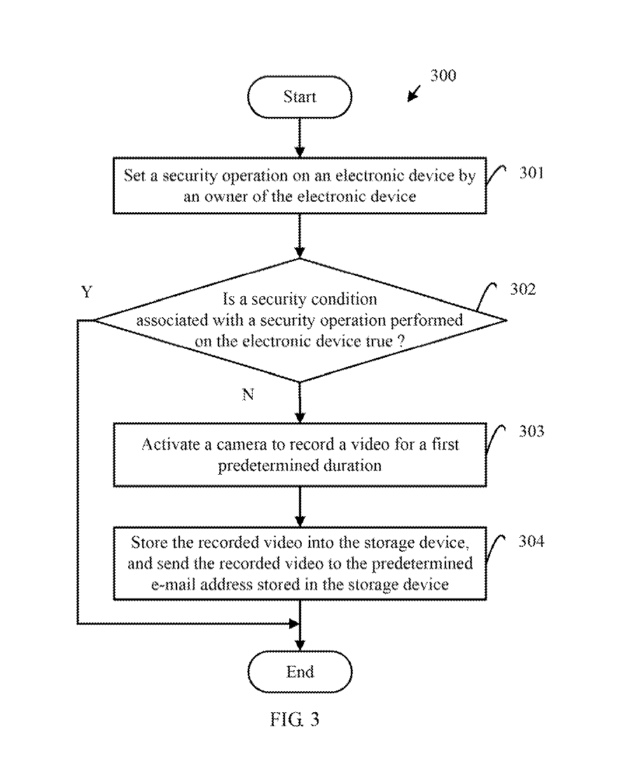

FIG. 3 illustrates a flowchart is presented in accordance with an example embodiment. An example method 300 is provided by way of example, as there are a variety of ways to carry out the method. The example method 300 described below can be carried out using the configurations illustrated in FIG. 1 and FIG. 2, and various elements of these figures are referenced in explaining the example method. Each block shown in FIG. 3 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, a setting module sets a security operation by an owner of the electronic device 1. In at least one embodiment, the setting module provides a user interface for the owner to execute one or more security operations on the electronic device 1.

At block 302, a determination module checks whether a security condition associated with a security operation performed on the electronic device 1 is true or false after the electronic device 1 is activated from a sleep mode. When the security condition associated with the security operation performed on the electronic device 1 is false, the procedure goes to block 303. When the security condition associated with the security operation performed on the electronic device 1 is true, the procedure ends. In an embodiment, the security condition is that the security operation is the first operation received by the electronic device 1 after the electronic device 1 is activated from the sleep mode. In another embodiment, the security condition is that the security operation is completely received by the electronic device 1 within a second predetermined duration after the electronic device 1 is activated from the sleep mode. In one embodiment, the second predetermined duration may be five seconds, ten seconds, one minute, three minutes, or five minutes, etc.

When the security condition associated with the security operation performed on the electronic device 1 is false, at block 303, the controlling module activates the camera 11 to record a video for a first predetermined duration. In some embodiments, the camera is set to a first side (e.g., a front side) of the electronic device 1 so that the camera 11 can capture a facial image of the current user of the electronic device 1. When the security condition associated with the security operation performed on the electronic device 1 is false, the current user of the electronic device 1 is determined not to be the owner of the electronic device 1. For example, the current user of the electronic device 1 may be a thief. Thus, the controlling module 104 turns on the camera 11 to record the video for the predetermined duration (e.g., 5 seconds) using the camera 11 to extract facial images of the current user of the electronic device 1. Through the extracted facial images of the current user, the current user may be identified and found.

At block 304, a sending module stores the recorded video into the storage device 12, and sends the recorded video to the predetermined e-mail address stored in the storage device 12. In at least one embodiment, the sending module turns on a wired or wireless network connection of the electronic device 1, and sends the video to the predetermined e-mail address through the network connection.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a camera, at least one processor; and
a storage device that stores one or more programs which, when executed by the at least one processor, cause the at least one processor to:
check whether a security condition associated with a security operation performed on the electronic device is true or false after the electronic device is activated from a sleep mode;
activate the camera to record a video for a first predetermined duration when the security condition is false; and
send the recorded video to a predetermined e-mail address stored in the storage device.

2. The electronic device according to claim 1, wherein the security condition is that the security operation is the first operation received by the electronic device after the electronic device is activated from the sleep mode.

3. The electronic device according to claim 1, wherein the security condition is that the security operation is completely received by the electronic device within a second predetermined duration after the electronic device is activated from the sleep mode.

4. The electronic device according to claim 1, wherein the security operation comprises executing at least one predetermined application of the electronic device.

5. The electronic device according to claim 4, wherein the predetermined application terminates immediately after the predetermined application is executed.

6. The electronic device according to claim 4, wherein the security operation further comprises at least one predetermined operation performed on the at least one predetermined application.

7. The electronic device according to claim 1, wherein the electronic device further comprises a touch screen and the security operation comprises dragging an icon of an application displayed by the touch screen along a predetermined path.

8. The electronic device according to claim 1, wherein the electronic device further comprises a touch screen and the security operation comprises a predetermined sequence of switching operations for switching a current desktop of a graphical user interface displayed by the touch screen.

9. The electronic device according to claim 1, wherein the electronic device further comprises a touch screen and the security operation comprises at least one predetermined operation performed on at least one predetermined menu of a graphical user interface displayed by the touch screen.

10. The electronic device according to claim 9, wherein the at least one predetermined menu comprises at least one predetermined menu item and the security operation further comprises selecting the at least one predetermined menu item.

11. The electronic device according to claim 10, wherein the predetermined menu item is a dummy menu item that has no function other than completing the security operation.

12. The electronic device according to claim 1, wherein the electronic device further comprises a touch screen and the security operation comprises at least one predetermined touch operation performed on the touch screen by an input tool.

13. The electronic device according to claim 1, wherein the electronic device further comprises at least one physical button and the security operation comprises at least one predetermined operation performed on the at least one physical button.

14. The electronic device according to claim 1, wherein the electronic device further comprises a motion sensor and the security operation comprises a predetermined moving of the electronic device detected by the motion sensor.

15. A computer-implemented method for protecting security of an electronic device being executed by at least one processor of the electronic device, the method comprising:
checking whether a security condition associated with a security operation performed on the electronic device is true or false after the electronic device is activated from a sleep mode;
activating a camera of the electronic device to record a video for a first predetermined duration when the security condition is false; and
sending the recorded video to a predetermined e-mail address stored in the storage device.

16. The method according to claim 15, wherein the security condition is that the security operation is the first operation received by the electronic device after the electronic device is activated from the sleep mode.

17. The method according to claim 15, wherein the security condition is that the security operation is completely received by the electronic device within a second predetermined duration after the electronic device is activated from the sleep mode.

18. A non-transitory storage medium having stored thereon instructions that, when executed by a processor of an electronic device, causes the processor to perform a method for protecting security of the electronic device, the method comprising:
checking whether a security condition associated with a security operation performed on the electronic device is true or false after the electronic device is activated from a sleep mode;
activating a camera of the electronic device to record a video for a first predetermined duration when the security condition is false; and
sending the recorded video to a predetermined e-mail address stored in the storage device.

19. The non-transitory storage medium according to claim 18, wherein the security condition is that the security operation is the first operation received by the electronic device after the electronic device is activated from the sleep mode.

20. The non-transitory storage medium according to claim 18, wherein the security condition is that the security operation is completely received by the electronic device within a second predetermined duration after the electronic device is activated from the sleep mode.
